(19) United States
(12) Patent Application Publication
(10) Pub. No.: US 2020/0294360 A1
(43) Pub. Date: Sep. 17, 2020

(54) GAMING SELECTION MANIPULATION APPARATUS

(71) Applicant: John C. House, Toronto (CA)

(72) Inventor: John C. House, Toronto (CA)

(21) Appl. No.: 16/299,054

(22) Filed: Mar. 11, 2019

(51) Int. Cl. G07F 17/32

(52) U.S. Cl. CPC G07F 17/3262; G07F 17/329

(57) ABSTRACT

An apparatus to facilitate pre-event and live event selection manipulation of lottery, gaming, or gambling selections including a receiver for receiving a request from a user to edit lottery, gaming, or gambling selections, a processing device to process the request, wherein the processing device generates a response message containing information regarding the changes made, and a transmitter for transmitting the response message to a communication device associated with the user, wherein the receiver receives a message from the communication device, and further processing device processes and edits lottery, gaming, or gambling selections as requested by the user, and further wherein the processing device determines if the edited lottery, gaming, or gambling selections constituent a winner, and further wherein a database stores user related data, game related data, and an audit trail of all manipulation transactions.

### BACKGROUND OF THE INVENTION

### A. Technical Field

The present invention pertains to an apparatus and method for facilitating the manipulation of previously chosen or assigned lottery, gaming, or gambling selections and, in particular, to an apparatus and method for facilitating lottery, gaming, or gambling selection manipulation via a user communication device.

### B. Description of Related Art

Many individuals like to gamble or engage in gaming activities and/or gaming events. People have typically been known to frequent casinos and/or other gaming establishments, racetracks, and/or other gaming venues and/or gambling venues. People also enjoy placing bets and/or betting or placing wagers on sporting events or other activities. People also participate in playing lottery games by selecting numbers at a lottery terminal.

While many individuals enjoy gambling and/or enjoy engaging in gaming, lottery and gambling activities, they are restricted from changing their lottery, gaming, or gambling selections after the initial bet is placed, lottery ticket is purchased, or contest is entered. Further, while many individuals may be interested in the option to make changes after their initial selection, they currently do not have access to a system, products, and/or services, to allow for such an action to be performed.

In view of the above, prior art gaming systems and/or gambling systems, as well as conventional gaming practices and/or gambling practices, have failed to provide the gambling, gaming, or lottery communities with a capability whereby they can change, edit, and/or replace their lottery, gaming, or gambling selections after the initial bet or selection is made. These changes can be made after the initial selection up to and including the duration of the event (i.e. prior to or during a live lottery ball selection process, prior to or during a live sporting/racing event, OR prior to or during any similar game where selections are made in advance of the event. This new capability would provide an enhanced gaming and/or gambling experience for participating individuals.

### SUMMARY OF THE INVENTION

The present invention discloses a gaming selection manipulation apparatus. In one embodiment, the apparatus comprises a communication device interface, a receiver, a processing device, and a transmitter. In one embodiment, the communication device interface comprises an input module, a display module, and a selection editing module. In one embodiment, the input module is configured to input previously made gaming selections. In one embodiment, the display module is configured to view previously made gaming selections. In one embodiment, the selection editing module is configured to edit previously made selections.

In one embodiment, the selection editing module is further configured to enable the user to increase or decrease a singular gaming selection or multiple gaming selections. The selection editing module enables the user to drop a selection or multiple selections and add a replacement selection or selections. The selection editing module is further configured to enable the user to replace a selection with a pre-defined selection. The selection editing module is further configured to enable the user to lock in the value of one or more selections. The selection editing module is further configured to enable the user to decline a boost the value of a selection by a pre-determined amount. The selection editing module is further configured to enable the user to add an additional selection.

In one embodiment, the receiver is configured to receive a request from a user to manipulate previously made gaming selections, wherein the receiver receives a message from the communication device.

In one embodiment, the processing device is configured to process the request for gaming selection. The processing device makes the requested change to selections, and further wherein stores the revised selections in a database. The processing device further identifies that a modified selection is a winner, and further wherein generates a response message containing information regarding the revised selections. The processing device is further configured to store an audit trail of all transactions related to manipulation activities.

In one embodiment, the transmitter is configured to transmit the response message to a communication device associated with the user.

In one embodiment, the apparatus further comprises a memory device for storing information regarding a user's request to be notified of a change in a gaming activity or a gaming event (such as start time, injury status, etc).

In one embodiment, the processing device detects a change regarding a gaming activity or a gaming event and processes the change utilizing information stored in the memory device. The processing device generates a notification message containing information regarding the gaming activity or gaming event, and further the transmitter transmits the notification message to a communication device associated with the user.

In one embodiment, the processing device generates at least one of a losing result message and a winning result message. The transmitter transmits the losing result message to a communication device associated with a losing user and transmits the winning result message to a communication device associated with a winning user.

Other objects and advantages of the present invention will be apparent to those skilled in the art upon a review of the Description of the Preferred Embodiments taken in conjunction with the Drawings which follow.

### BRIEF DESCRIPTION OF DRAWINGS

The embodiments herein will be better understood from the following detailed description with reference to the drawings, in which:

FIG. 1 exemplarily illustrates a block diagram of an environment implemented for gaming selection manipulation apparatus, according to one embodiment of the present invention.

### DETAILED DESCRIPTION OF EMBODIMENTS

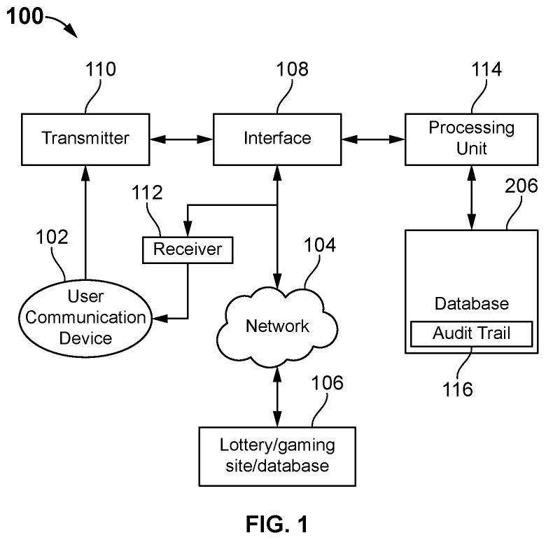

The present invention pertains to an apparatus and method for facilitating the manipulation of lottery, gaming, or gambling selections which is not covered in any prior art. FIG. 1 exemplarily illustrates a block diagram of an environment implemented for gaming selection manipulation apparatus 100, according to one embodiment of the present invention. The present invention pertains to an apparatus 100 and method for facilitating the manipulation of lottery, gaming, or gambling selections via a user communication device 102. The present invention can be utilized in order to allow a user to engage in facilitating the manipulation of lottery, gaming, or gambling selections via a user communication device 102. The present invention can also be utilized in order to facilitate the manipulation of lottery, gaming, or gambling selections in a network environment 104.

The present invention can also be utilized in order to provide account security for any one or more wireless communication device account(s), and/or a cellular communication device account(s), utilized in conjunction with a user profile account.

A user/player may purchase a paper ticket at a lottery terminal and use a personal communication device 102 to scan a barcode or other tracking mechanism to capture initial selections. Furthermore, initial selections can be stored in the associated database 106.

The present invention can be utilized in order to allow a user or individual to manipulate lottery, gaming, or gambling selections, at one lottery, gaming, or gambling web site, or at a plurality of lottery, gaming, or gambling web sites, remotely via a user communication device 102.

The user's display screen, which can be a component of, or associated with, the user's user communication device or computer, can display the user's current selections and offer capability to edit previously made selections.

The user or player can utilize an input device or an interactive device or an interface 108 in order to make lottery, gaming, or gambling selection changes via increase/decrease interface options, drop/add interface options, lock interface options, or other interface manipulation options. Said communication device interface 108 comprises an input module to input previously made gaming selections, a display module to view previously made gaming selections, and a selection editing module to edit previously made selections.

The selection editing module is further configured to enable the user to increase or decrease a singular Gaming selection or multiple Gaming selections. The selection editing module is further configured to enable the user to drop a selection or multiple selections and add a replacement selection or selections. The selection editing module is further configured to enable the user to replace a selection with a pre-defined selection. The selection editing module is further configured to enable the user to lock in the value of one or more selections. The selection editing module is further configured to enable the user to decline a boost the value of a selection by a pre-determined amount. The selection editing module is further configured to enable the user to add an additional selection.

The system can also be programmed to limit/restrict the amount of change that can be made to selections.

A database 206 associated with the account can be programed to store user/player account information, lottery/gaming information, and an audit trail 116 of all transactions performed by the user/player while logged into the system. In one embodiment, the audit trail 116 could be done utilizing blockchain technology.

The limitations or restrictions on use of a user's account or communication device can include limitation or a restriction of a negative limitation or restriction (i.e. a gaming activity which is not allowed to be manipulated; a time period(s) during which gaming manipulating activities are not allowed, etc.) or a positive limitation or restriction (i.e. a gaming activity allowed to be manipulated, a time period(s) during which gaming manipulation is allowed, etc.).

The present invention can also be utilized to provide information for and/or to promote gaming activities or gambling activities. Information regarding gaming activities or gambling activities can be stored via a central processing computer or server computer or processing unit or processing device 114 to an associated database 206. Information regarding a gaming activity or event (i.e. games at a casino, a sporting event, fantasy sports site, etc.) can be entered by an individual or enterprise who or which may access the central processing computer or server computer and transmit the information regarding the gaming activity or event to the central processing computer or server computer 114 which can then store the information in a database 206. A user can access the central processing computer and request information regarding any gaming activity or event and receive the information if such information exists.

The present invention can also be utilized in conjunction with state gaming activities of a respective state, country or sovereignty. In this manner, the present invention can be utilized in a manner consistent with gaming laws, rules, and/or regulations, in the various states, countries or sovereignties, in which, or in conjunction with the present invention can be utilized. In this manner, the present invention can be utilized to facilitate compliance with the various and respective state, country, and/or sovereignty, gaming laws and/or gambling laws and/or so as to facilitate any reporting of gaming activities and/or gambling activities to the appropriate authorities.

The present invention can also be utilized in order to facilitate the manipulation of state/provincial/federal lottery games from any state/province or country.

The present invention can be utilized in conjunction with any gaming activities, gambling activities, and/or games of chance, including, but not limited to Keno, lottery games, state or other subdivision lottery games, Powerball lottery games, horse racing, dog racing, off track betting games, football games, professional football games, college football games, high school football games, little league football games, championship football games or series, baseball games, baseball football games, college baseball games, high school baseball games, little league baseball games, championship baseball games or series, basketball games, professional basketball games, college basketball games, high school basketball games, little league basketball games, championship basketball games or series, professional soccer games, college soccer games, high school soccer games, little league soccer games, championship soccer games or series, professional hockey games, college hockey games, high hockey soccer games, little league hockey games, championship hockey games or series, tennis matches, wrestling matches, boxing matches, golf tournament, and/or games, matches, tournaments, daily fantasy sports games, fantasy sports games, and/or competitions of any type or kind.

The present invention can also be utilized to provide gaming results or gambling results to a user or player.

The apparatus can include one or more of a central processing computer(s) or server computer(s) 114, a user communication device(s), a gaming facility computer(s), and/or a governmental entity computer(s), each of which can be capable of communicating with any of the other respective computers or user communication device(s).

The manipulation processing unit 114 described herein can be integrated with any government, casino, fantasy sports site, daily fantasy sports site, or other entity running a gaming, lottery or gambling service.

Each of central processing computer(s) or server computer(s), the gaming facility computer(s), the financial institution computer(s), and/or the governmental entity computer(s), can have a web site or web sites associated therewith.

The present invention can be utilized over any suitable communication network 104 and/or any combination of computer networks, including, but not limited to the Internet, the World Wide Web, a telecommunication network or system, a telephone network or system, a cable television communication network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video communication network or system, a streaming audio communication network or system, a live video communication network or system, and/or any other suitable communications network or system, and/or any combination(s) thereof.

Each of the central processing computer(s) or server computer(s) 114, the user communication device(s) 102, the gaming facility computer(s), the financial institution computer(s), and/or the governmental entity computer(s), can include a central processing unit (CPU), a read only memory (ROM) device, a random access memory (RAM) device, a user input device(s), a display device, an output device, a database(s), a receiver 112, a transmitter 110, and/or a global positioning device.

A central processing computer and/or a gaming facility computer 114 can also process changes in order to allow the user to manipulate lottery, gaming, or gambling selections on any of the gaming events which can be accessed via the central processing computer and/or any of the gaming facility computers.

The gaming facility computer associated with a gaming facility can be utilized in order to perform any of the functionality described herein as being provided by the central processing computer 114.

A user or users can request to be notified upon an availability of a gaming event, a posting of a gaming event, and/or a presence of a gaming event.

A user can also request to be notified if betting odds change regarding an gaming event (i.e. a certain race horse is now paying two to one odds, a handicap or spread for a game has changed (i.e. the NFC team in the NFL Super Bowl formerly favored by three points is now favored by ten points over the AFC team, etc.). Information regarding these types of requests can also be contained in the message transmitted by the user to the central processing computer and/or the particular gaming facility computer 114.

The central processing computer and/or the gaming computer 114 can detect a gaming event or gaming events for which the user has desired to be notified and can notify the user regarding the gaming event or gaming events by transmitting a user notification message to the user communication device associated with the user.

The user notification message can contain information regarding the gaming event or gaming events, any additional requested information regarding the gaming event or gaming events (i.e. lottery odds of winning, last winning draw, last winning pay out, odds of winning, slot pay outs, frequency of user wins, amount of user wins, teams records, sports players records, averages, and/or statistics, and/or any statistical and/or historical records regarding any of the herein described gaming events, information regarding previous winning numbers and the probabilistic information regarding same, player statistics against an opposing team, historical records regarding prior meetings of the teams, player injuries, line-ups for the game, etc., and any other information which a user may find desirable in having prior to manipulating selections for a gaming event, etc.).

The present invention can be utilized in order to facilitate lottery, gaming, or gambling selection manipulation from a remote location. The present invention can also be utilized in order to facilitate lottery, gaming, or gambling selection manipulation at a gaming venue remote from a user's or individual's physical location. The present invention can also be utilized in order to facilitate lottery, gaming, or gambling selection manipulation via a user communication device.

Information regarding a gaming activity and/or gaming event (i.e. a game(s) at a casino or betting hall, a horse race, a sporting event, etc.) can be entered by an individual or enterprise who or which may access the central processing computer and/or gaming facility computer and transmit the pertinent information and/or enter the pertinent information regarding the gaming activity and/or gaming event into the respective central processing computer and/or gaming facility computer so as to thereby “post” the information at the respective central processing computer and/or gaming facility computer.

The information regarding the gaming activity and/or gaming event can also include information regarding changed odds of winning, a changed score spread, an increased lottery prize or jackpot, a changed and/or updated historical and/or statistical information, and/or new and/or updated information regarding the gaming activity and/or gaming event, new and/or updated information and/or statistics regarding any of the gaming activities, gaming events, gambling activities, and/or gambling events, and/or any of the teams, players, athletes, participants, animals (i.e. horses in horse racing, etc.), which may be involved in or be the subject of any of the gaming activities, gaming events, gambling activities, and/or gambling events. New and/or updated information can also include, but not be limited, to a casino's win percentage for a slot machine or for a table game, the average winnings of the house, users' or players' winning percentages, users' or players' losing percentages, average losses by users or players, a professional boxer's won/loss record, a sports team's won/loss record and/or historic record against another team, a respective athlete's batting average, rushing average, scoring average, etc., and past statistics or performance against a specific opponent, a race horse's racing won/loss record and/or statistics in a given setting, and/or any other information which a user or player may be interested in obtaining in order to make informed changes.

The present invention can alert a user of, and/or provide a user with, any new or updated information regarding a gaming activity and/or gaming event.

The information regarding the gaming activity and/or gaming event can then be stored in a respective database 206 of a respective central processing computer and/or gaming facility computer 114 and can be retrieved via a user search and/or user searching activity and/or by automatic message generation by the respective central processing computer and/or gaming facility computer. A user can also pre-request to be automatically notified, or receive an alert regarding a posting or postings of new gaming activities and/or gaming events and/or new and/or updated information regarding the gaming activity and/or gaming event.

A user can also program a respective central processing computer and/or gaming facility computer to provide him or her with notification of any new gaming activities or gaming events and/or new and/or updated information regarding gaming activities and/or gaming events about which the user desires to be notified.

A user can also access a respective central processing computer and/or gaming facility computer and search for information regarding a gaming activity, gaming activities, a gaming event, gaming events, and/or new and/or updated information regarding same.

The present invention can also be utilized in conjunction with state gaming activities of a respective state, country or sovereignty. As used herein the term “state” means any state, region, territory, and/or possession of the United States of America, any nation, country, sovereign state, monarchy, principality, and/or any region, territory, possession, and/or subdivision of same. In this manner, the present invention can be utilized in a manner consistent with gaming laws, rules, and/or regulations, in the various states, countries, or sovereignties, in which, or in conjunction with which, the present invention can be utilized.

The present invention can also be utilized in order to allow a user to manipulate lottery selections in any number of states, countries, and/or other localities. The present invention can be utilized to determine a user's originating state and can facilitate the playing of a lottery game or games, including the collection of winnings and/or prizes for and/or on behalf of the user for any number of state lottery games.

Accordingly, it is an object of the present invention to provide an apparatus and method for facilitating gaming/gambling selection manipulation prior to the start of or during the event, lottery draw, or other gaming or gambling activity.

It is another object of the present invention to provide an apparatus and method for facilitating selection lottery, gaming, or gambling manipulation which can be facilitated via a user communication device.

It is still another object of the present invention to provide an apparatus and method for facilitating lottery, gaming, or gambling selection manipulation via a communication network 104.

It is yet another object of the present invention to provide an apparatus and method for facilitating selection manipulation which can process information regarding gaming activity and/or gambling activity.

It is another object of the present invention to provide an apparatus and method for facilitating selection manipulation which can provide information regarding gaming activity and/or gambling activity.

It is another object of the present invention to provide an apparatus and method for facilitating gaming activity and/or gambling activity which facilitates lottery, gaming, or gambling selection manipulation activities in a network environment 104.

It is yet another object of the present invention to provide an apparatus and method for facilitating lottery, gaming, or gambling selection manipulation activity which can be utilized in order to allow a user or individual to pre-request to receive information regarding the occurrence of a gaming event or a gambling event.

It is another object of the present invention to provide an apparatus and method for facilitating gaming activity and/or gambling activity which can be utilized in order to provide a real-time as well as a non-real-time alert or notification message to a user or individual communication device for informing a user of any one or more of a gaming event, a gambling event, gaming activity, gambling activity, and/or of information regarding a gaming event and/or a gambling event.

It is another object of the present invention to provide an apparatus and method for facilitating manipulation of lottery, gaming, or gambling selections which can be utilized in order to provide information regarding and/or relating to a gaming activity or a gaming event.

It is another object of the present invention to provide an apparatus and method for facilitating manipulation of lottery, gaming, or gambling selections which can be utilized in conjunction with state gaming activities.

It is still another object of the present invention to provide an apparatus and method for facilitating manipulation of lottery, gaming, or gambling selections which can be utilized in order to facilitate the playing of state lottery games from any state or country.

It is another object of the present invention to provide an apparatus and method for facilitating manipulation of lottery, gaming, or gambling selections which can be utilized over any suitable communication network 104, including, but not limited to the Internet, the World Wide Web, a telecommunication network or system, a telephone network or system, a cable television communication network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video communication network or system, a streaming audio communication network or system, a live video communication network or system, and/or any other suitable communications network or system, and/or any combination(s) thereof.

It is yet another object of the present invention to provide an apparatus and method for facilitating manipulation of lottery, gaming, or gambling selections which can be utilized in order to determine or identify a state or a jurisdiction from which a gaming activity and/or a gambling activity originates.

It is still another object of the present invention to provide an apparatus and method for facilitating manipulation of lottery, gaming, or gambling selections which can be utilized in order to allow a user to manipulate lottery/fantasy sports/gambling/sports betting games in any number of states, countries, and/or other localities.

What is claimed is:

1. A Gaming selection manipulation apparatus, comprising:
a communication device interface comprising,
Input module to input previously made gaming selections;
Display module to view previously made gaming selections; and
Selection editing module to edit previously made selections.
a receiver for receiving a request from a user to manipulate previously made Gaming selections, wherein the receiver receives a message from the communication device,
a processing device for processing the request, wherein the processing device makes the requested change to selections, and further wherein stores the revised selections in a database, and further wherein identifies that a modified selection is a winner, and further wherein generates a response message containing information regarding the revised selections; and
further wherein the processing device stores an audit trail of all transactions related to manipulation activities; and
a transmitter for transmitting the response message to a communication device associated with the user.

2. The apparatus of claim 1, wherein the selection editing module is further configured to enable the user to increase or decrease a singular Gaming selection or multiple Gaming selections.

3. The apparatus of claim 1, wherein the selection editing module is further configured to enable the user to drop a selection or multiple selections and add a replacement selection or selections.

4. The apparatus of claim 1, wherein the selection editing module is further configured to enable the user to replace a selection with a pre-defined selection.

5. The apparatus of claim 1, wherein the selection editing module is further configured to enable the user to lock in the value of one or more selections.

6. The apparatus of claim 1, wherein the selection editing module is further configured to enable the user to decline a boost the value of a selection by pre-determined amount.

7. The apparatus of claim 1, wherein the selection editing module is further configured to enable the user to add an additional selection.

8. The apparatus of claim 1, further comprising:
a memory device for storing information regarding a user's request to be notified of a change in a gaming activity or a gaming event;
wherein the processing device detects a change regarding a gaming activity or a gaming event, wherein the processing device processes the change utilizing information stored in the memory device, wherein the processing device generates a notification message containing information regarding the gaming activity or gaming event, and further wherein the transmitter transmits the notification message to a communication device associated with the user.

9. The apparatus of claim 8, wherein the processing device generates at least one of a losing result message and a winning result message, and further wherein the transmitter transmits the losing result message to a communication device associated with a losing user and transmits the winning result message to a communication device associated with a winning user.
